(19) United States
(12) Patent Application Publication
(10) Pub. No.: US 2006/0076747 A1
(43) Pub. Date: Apr. 13, 2006

(54) Wheelchair suspension system

(75) Inventors: Darryl R. Pauls, Visalia, CA (US); Samuel D. Traxinger, Fresno, CA (US)

Correspondence Address: MACMILLAN SOBANSKI & TODD, LLC;ONE MARITIME PLAZA FOURTH FLOOR, 720 WATER STREET, TOLEDO, OH, 43604-1619, US

(73) Assignee: Sunrise Medical HHG Inc.

(21) Appl. No.: 11/244,933

(22) Filed: Oct. 6, 2005

Related U.S. Application Data
(60) Provisional application No. 60/617,525, filed on Oct. 8, 2004.
(60) Provisional application No. 60/621,272, filed on Oct. 22, 2004.
(60) Provisional application No. 60/621,432, filed on Oct. 22, 2004.

(51) Int. Cl. B60G 9/00

(52) U.S. Cl. 280/124.11

(57) ABSTRACT

A wheelchair has a suspension system that includes a front caster housing mounted forward of a wheelchair frame by means of a front linkage. The front caster housing supports a front caster. A drive wheel pivot arm, on which a mid-wheel-drive drive wheel is mounted, is itself mounted for pivoting with respect to the frame. A flexible tension member is connected to both the drive wheel pivot arm and the front linkage. The mounting of the flexible tension member is configured so that rotation of the drive wheel pivot arm in a downward direction applies tension to the flexible tension member, causing the upper link to rotate upward, and thereby lifting the caster housing and the front caster.

### RELATED APPLICATIONS

This application claims priority from U.S. Provisional Patent Application Ser. No. 60/617,525, filed Oct. 8, 2004, and entitled WHEELCHAIR SUSPENSION SYSTEM. This application also claims priority from U.S. Provisional Patent Application Ser. No. 60/621,272, filed Oct. 22, 2004, and entitled WHEELCHAIR WITH TENSION MEMBER BETWEEN PIVOT ARMS. Further, this application claims priority from U.S. Provisional Patent Application Ser. No. 60/621,432, filed Oct. 22, 2004, and entitled WHEELCHAIR SUSPENSION WITH SWAYBAR.

### TECHNICAL FIELD

This invention relates to suspension systems for wheelchairs and other personal mobility vehicles.

### BACKGROUND OF THE INVENTION

Wheelchairs are designed to provide mobility for physically challenged users. Power wheelchairs generally include a base frame supported on the ground by a combination of drive wheels and idler or anti-tip wheels. Mounted on the base frame are a seat and a seat back for supporting the wheelchair user. Power wheelchairs are provided with a suspension system to cushion the wheelchair user from an uneven supporting surface and thereby provide a smooth ride for the user. Wheelchair suspension systems can include drive wheel pivot arms on which the drive wheels are mounted, allowing the drive wheels to move up and down relative to the wheelchair base frame to accommodate variations in the supporting surface. It would be advantageous if there could be developed an improved wheelchair suspension system.

### SUMMARY OF THE INVENTION

The above objects as well as other objects not specifically enumerated are achieved by a wheelchair that has a suspension system that includes a front caster housing mounted forward of a wheelchair frame by means of a front linkage. The front caster housing supports a front caster. A drive wheel pivot arm, on which a mid-wheel-drive drive wheel is mounted, is itself mounted for pivoting with respect to the frame. A flexible tension member is connected to both the drive wheel pivot arm and the front linkage. The mounting of the flexible tension member is configured so that rotation of the drive wheel pivot arm in a downward direction applies tension to the flexible tension member, causing the upper link to rotate upward, and thereby lifting the caster housing and the front caster.

According to this invention there is also provided a wheelchair with a suspension system that includes a front caster housing mounted forward of a wheelchair frame by means of a front linkage, with the front caster housing supporting a front caster. A drive wheel pivot arm, on which a mid-wheel-drive drive wheel is mounted, is itself mounted for pivoting with respect to the frame. A tension link is connected to both the drive wheel pivot arm and the front linkage, the mounting of the tension link being configured so that under normal operating conditions the tension link pulls the front linkage in a substantially downward direction, with the mounting of the tension link being configured so that rotation of the drive wheel pivot arm in a downward direction releases tension in the tension link, allowing the front linkage to more freely move upward.

According to this invention there is also provided a wheelchair having a frame and a drive wheel pivot arm on each side of the wheelchair, each drive wheel pivot arm being mounted for pivoting with respect to the frame. A drive wheel is mounted on each drive wheel pivot arm. A torsion member is connected to each of the drive wheel pivot arms, thereby causing the two drive wheel pivot arms to tend to pivot in unison.

According to this invention there is also provided a wheelchair having a frame and a drive wheel pivot arm on each side of the wheelchair. Each drive wheel pivot arm is mounted for pivoting with respect to the frame, with a drive wheel mounted on each drive wheel pivot arm. A torsion member is comprised of a main cross leg and two end legs, each end leg being connected to a drive wheel pivot arm.

According to this invention there is also provided a wheelchair with a suspension system that includes a drive wheel and a front caster housing in which a front caster wheel is mounted. Also included is a front linkage supporting the front caster housing and connecting the front caster housing to the wheelchair frame, with the front linkage including upper and lower links connected at forward ends to the front caster housing, and connected at rearward ends to a pivot member that is pivotally mounted to the frame.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic elevational view of a wheelchair.

FIG. 2 is a schematic side elevational view of the suspension system of the wheelchair.

FIG. 3 is a schematic side elevational view of the front of the suspension system of the wheelchair.

FIG. 4 is schematic view in perspective of the front end of the wheelchair.

FIG. 5 is a schematic side elevational view of another suspension system of the wheelchair, showing the upper and lower link pivot points are attached to a pivotally mounted member.

### DETAILED DESCRIPTION OF THE INVENTION

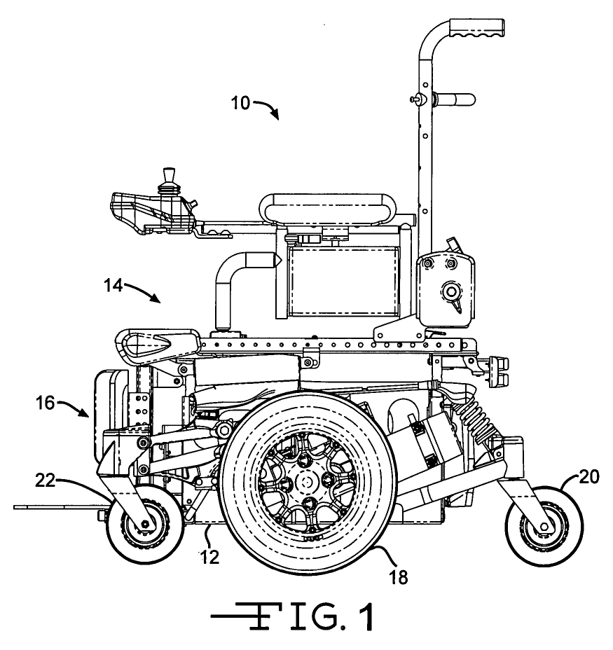

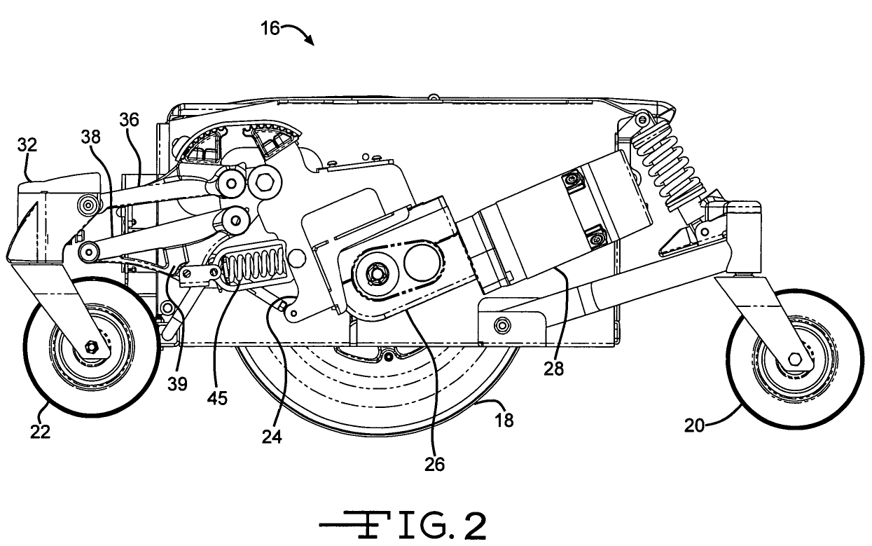

Some of the structural features of the suspension and the wheelchair itself are shown in FIGS. 1-3. As shown in FIG. 1, the wheelchair 10 includes a frame 12 on which is mounted the seat 14. The suspension 16 provides a mounting of the midwheel drive wheels 18, one or more rear caster wheels 20 and one or more front caster wheels 22 to the frame 12 As shown in FIG. 2, the wheelchair suspension includes a drive wheel pivot arm 24 on which is mounted the gearbox 26, motor 28, and the drive wheel 18 (not shown in FIG. 2, but mounted from the gear box).

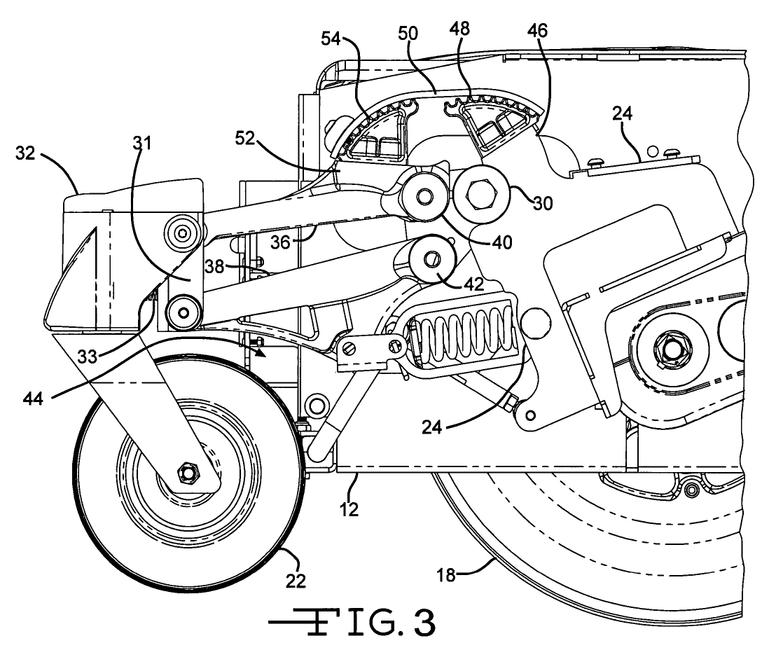

As shown in FIG. 3, the drive wheel pivot arm 24 is mounted to pivot at a pivot point 30, which is fixed with respect to the frame 12. This enables the drive wheel pivot arm 24, and hence the drive wheel 18, to move up and down with respect to the frame 12 to provide a smooth ride for the wheelchair user, even when the surface underlying the wheelchair is uneven.

The front casters 22 are mounted in a caster housing 32, which is pivotally mounted to the frame 12 by means of a front linkage, which is optionally comprised of upper and lower linkages 36 and 38, respectively. These linkages 36 and 38 are attached to the frame 12 at fixed pivot points 40 and 42, respectively, to form a 4-bar link 44. The 4-bar link consists of the frame 12, the front mounting bar 31, and the upper and lower caster links 36 and 38. Optionally, a wave washer spring set 33 is positioned between the front caster housing 32 and the front mounting bar 31 so that when the front caster 22 bumps into a fixed obstacle, such as a wall, the front caster housing 32 and the front caster 22 can flex or spring back (rearward) to lessen the force of the impact on the wheelchair. The rearward movement of the front caster is caused by the impact of the front caster 22 against an object, and the rearward movement is not caused by any pivoting of the drive wheel pivot arm 24.

The 4-bar link 44 is configured in such a way that when the front caster 22 is moved upward by the action of the motor torque on the pivot arm 24, the front caster 22 moves slightly forward with respect to the frame 12. Further, the 4-bar link is configured so that the front caster 22 is never moved rearwardly with respect to the frame 12 throughout its entire range of motion when the front caster 22 is lifted up by the action of the motor torque on the pivot arm 24. The geometry of the 4-bar link, including the placement of pivot points 40 and 42 on the frame 12, and including the lengths of the upper and lower caster linkages 36, 38 dictates this forward-only motion as the front caster is lifted up by the rotation of the pivot arm 24.

The upper flange or leg 46 of the drive wheel pivot arm 24 includes a rear attachment block 48 for connecting one end of a flexible tension belt 50 to the drive wheel pivot arm 24. The attachment block 48 and the leg 46 are both rigidly fixed to the drive wheel pivot arm 24. It can be seen that when the drive wheel pivot arm 24 rotates in a downward direction about pivot point 30, the upper leg 46 will rotate in the same direction about the pivot point 30, thereby pulling the tension belt 50 in a rearward direction. The rotation of the drive wheel pivot arm 24 in the downward direction would be in a clockwise direction as shown in the drawings, which depict the left hand side of the wheelchair. When viewing the right hand side of the wheelchair, the downward rotation of the drive wheel pivot arm 24 would be in a counterclockwise direction. The upper caster link 36 includes an upper flange or leg 52 on which is mounted a forward attachment block 54 that is similar to the attachment block 48. The forward attachment block 54 connects the forward end of the tension belt 50 to the upper caster link 36. The forward attachment block 48 and the leg 52 are both rigidly fixed to the upper caster link 36. When torque from the motor 28 causes the drive wheel pivot arm 24 to rotate clockwise (as viewed in FIG. 3) about its pivot point 30, the upper leg 46 of the drive wheel pivot arm 24 will also rotate clockwise (as viewed in FIG. 3), moving upwardly about its pivot point 40, and the tension belt 50 is pulled by the rear attachment block 48. This rearward pulling of the tension belt 50 causes the forward attachment block 54 to be pulled downwardly and rearwardly, therefore rotating the entire upper caster link 36 upward and clockwise (as viewed in FIG. 3) about its pivot point 40 (which is itself fixed to the frame 12). Rotation of the upper caster link 36 lifts the caster housing 32 and the front caster 22 from the ground because of the 4-bar link arrangement 44, thereby enabling the wheelchair 10 to more successfully negotiate obstacles.

The flexible tension belt 50 can be of any form suitable for being placed under tension to transfer rotative force of the drive wheel pivot arm 24 to the upper caster link 36. The tension belt 50 is configured to be able to transmit tensile force, but not compressive force. The connection between the flexible tension belt 50 and the attachment blocks 48 and 54 is a fixed connection, and is not a pivotal connection. The attachment blocks 48 and 54 need not be completely circular, but as shown they can have a structure that is only a portion of a circle, such as a quarter circle, so that they will not interfere with each other. The attachment blocks 48 and 54 can be sized similarly, or can be of different radii for gearing purposes. Also, the attachment blocks 48 and 54 can have a circular outline or profile, as shown, or can be oval or elliptical, or of other geometric shapes, for tuning purposes.

The lower caster linkage 38 includes an optional attachment flange 39. An optional tension link, such as a tensile spring assembly 45, is mounted between the drive wheel pivot arm 24 and the attachment flange 39 of the lower caster linkage 38. Other types of tension links can be used. Under normal operating conditions, when the drive wheel pivot arm 24 is not pivoted, the tensile spring assembly 45 pulls the lower caster linkage 38 rearward and downward about its pivot point 42, and hence the caster housing 32 and the front caster 22 are pulled downward into contact with the ground. When the drive wheel pivot arm 24 pivots or rotates because of the torque of the motor 28, however, the rotation about pivot point 30 causes the distance between the drive wheel pivot arm 24 and the lower caster linkage 38 to be shortened. This will diminish or eliminate the downward force of the tensile spring assembly 45 on the lower caster linkage 38, allowing the front caster 22 to be more easily lifted up to clear obstacles.

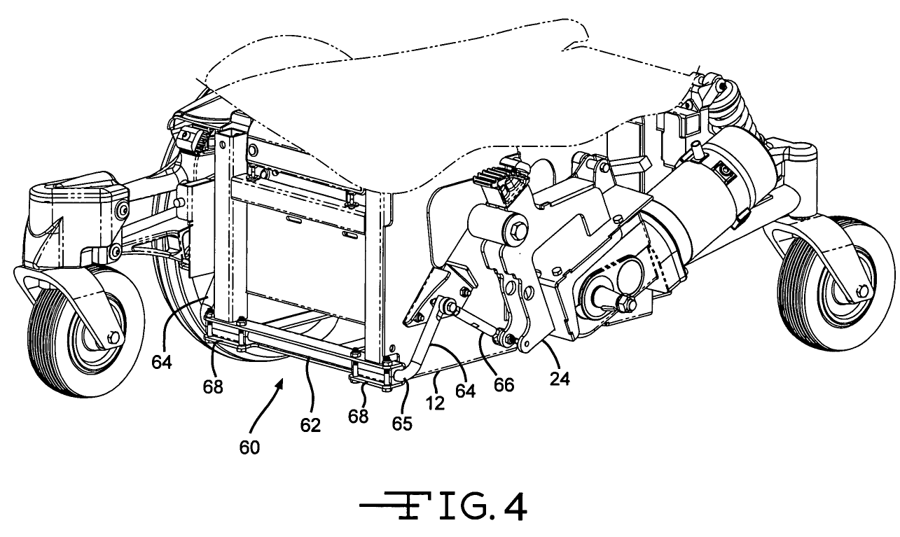

As shown in FIG. 4, an anti-sway bar 60 is mounted at the front of the wheelchair. The anti-sway bar 60 connects the suspension on the left side of the wheelchair to the suspension on the right side of the wheelchair. The resistance to torsional deflection of the anti-sway bar 60 reduces the amount of roll experienced by the wheelchair and by the wheelchair occupant about a horizontal axis that extends through the fore/aft centerline of the wheelchair.

The anti-sway bar 60 is preferably comprised of a main cross leg 62 and two end legs 64 connected at corners 65. The end legs 64 of the anti-sway bar 60 are each connected to a drive wheel pivot arm 24 by means of linkages 66. It is to be understood that any mechanism suitable for connecting the end legs 64 of the anti-sway bar 60 to the drive wheel pivot arm 24 can be used. Preferably, the linkage 66 is adjustable, as shown, allowing the length of the linkage to be modified. The anti-sway bar 60 reduces the amount of wheelchair and occupant roll about a horizontal axis that extends in a forward/rearward direction through the fore/aft centerline of the wheelchair. The anti-sway bar 60 acts to limit the movement of the drive wheel pivot arm 24 about its suspension pivot point 30 without causing a substantially corresponding movement in the opposite drive wheel pivot arm 24 by virtue of the anti-sway bar's own resistance to torsional deflection. The device will not restrict motion of both drive wheel pivot arms when they pivot in the same direction.

The anti-sway bar 60 can be any torsion member suitable for affecting the relative pivotal motion of the two drive wheel pivot arms 24. The torsional stiffness of the anti-sway bar 60 will affect how closely the two pivot arms 24 are tied together, i.e., how much rotational deviation is allowed between one of the drive wheel pivot arms and the other drive wheel pivot arm.

The anti-sway bar 60 can be attached rigidly to the drive wheel pivot arm 24, or it can be rotationally attached to the wheelchair frame 12 and to the drive wheel pivot arms 24 through the linkages 66, as shown. The anti-sway bar 60 could also be configured as a rotational mounting member for the drive wheel pivot arm 24, allowing the drive wheel pivot arm 24 to act as the torsional member extension levers. To accomplish this, the anti-sway bar 60 is configured so that the main cross leg 62 is disconnected from each of the two end legs 64, but joined with a connector, not shown. By using a connector, different materials, and materials having different torsion qualities can be used for the main cross leg 62 and two end legs 64. The use of a connector allows the different elements 62 and 64 to be selected independently to suit the individual design of any particular wheelchair. Also, end legs 64 of different lengths can be substituted where desired. Further, the connector can be splined to enable a preset torque on the anti-sway bar 60. Also, extension levers can be used on the end legs 64.

As shown in FIG. 4, anti-sway bar 60 is rotationally attached or mounted to the wheel chair frame 12 through sleeve type polymer bearing blocks 68 at the ends of the main cross leg 62. Any other means suitable for mounting the anti-sway bar 60 can be used. The linkages 66 that extend between the drive wheel pivot arm 24 and the torsional member end legs 64 are pivotally attached to both the drive wheel pivot arms 24 and the two end legs 64 so that pivotal movement of drive wheel pivot arms 24 is not dependent on having the torsional member axis of rotation at the same location and in the same direction as the axis of rotation of the drive wheel pivot arm 24.

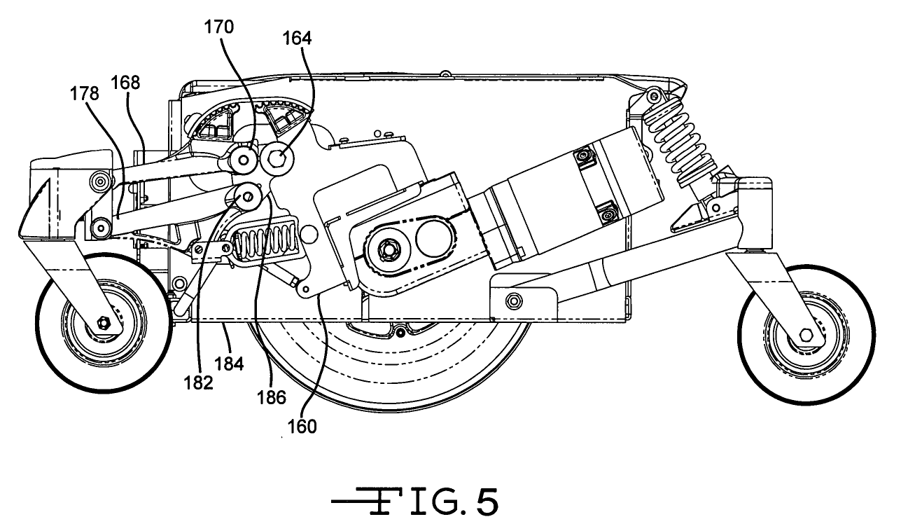

In an another embodiment of the invention, shown in FIG. 5, the upper link pivot point 170 and the lower link pivot point 182 are not fixed to the wheelchair frame 184, but rather are attached to a pivotally mounted pivot member, shown as forward extension 186, that pivots with and is attached to the drive wheel pivot arm 160. The forward extension 186 and the pivot arm 160 both pivot about pivot point 164. Hence the upper link pivot point 170 and lower link pivot point 182 also pivot about pivot point 164.

The principle and mode of operation of this invention have been described in its preferred embodiments. However, it should be noted that this invention may be practiced otherwise than as specifically illustrated and described without departing from its scope.

What is claimed is:

1. A wheelchair with a suspension system comprising:
a front caster housing mounted forward of a wheelchair frame by means of a front linkage, the front caster housing supporting a front caster;
a drive wheel pivot arm on which a mid-wheel-drive drive wheel is mounted, the drive wheel pivot arm being mounted for pivoting with respect to the frame; and
a flexible tension member connected to both the drive wheel pivot arm and the front linkage, the mounting of the flexible tension member being configured so that rotation of the drive wheel pivot arm in a downward direction applies tension to the flexible tension member, causing the upper link to rotate upward, and thereby lifting the caster housing and the front caster.

2. The wheelchair of claim 1 in which the flexible tension member is a belt.

3. The wheelchair of claim 1 in which the drive wheel pivot arm is mounted for pivoting at a pivot point, and in which the connection between the flexible tension member and the drive wheel pivot arm is at a position on the drive wheel pivot arm that is above the pivot point.

4. The wheelchair of claim 1 in which the front linkage is an upper front linkage, and further including a lower front linkage, with the upper front linkage, the lower front linkage, the caster housing and the frame forming a 4-bar link.

5. The wheelchair of claim 4 in which the 4-bar link 44 is configured in such a way that when the front caster is moved upward by the action of rotation of the drive wheel pivot arm, the front caster moves forward with respect to the frame.

6. The wheelchair of claim 4 in which the 4-bar link is configured so that the front caster does not move rearwardly with respect to the frame throughout its entire range of motion when the front caster is lifted up by the action of rotation of the drive wheel pivot arm.

7. A wheelchair with a suspension system comprising:
a front caster housing mounted forward of a wheelchair frame by means of a front linkage, the front caster housing supporting a front caster;
a drive wheel pivot arm on which a mid-wheel-drive drive wheel is mounted, the drive wheel pivot arm being mounted for pivoting with respect to the frame; and
a tension link connected to both the drive wheel pivot arm and the front linkage, the mounting of the tension link being configured so that under normal operating conditions the tension link pulls the front linkage in a substantially downward direction, with the mounting of the tension link being configured so that rotation of the drive wheel pivot arm in a downward direction releases tension in the tension link, allowing the front linkage to more freely move upward.

8. The wheelchair of claim 7 in which the tension link is a tensile spring assembly.

9. The wheelchair of claim 7 in with the front linkage is a lower front linkage, and further including an upper front linkage, with the upper front linkage, the lower front linkage, the caster housing and the frame forming a 4-bar link, and with the tension link being connected to the lower front linkage.

10. The wheelchair of claim 7 in which the drive wheel pivot arm is mounted for pivoting at a pivot point, and in which the connection between the tension link and the drive wheel pivot arm is at a position on the drive wheel pivot arm that is below the pivot point.

11. A wheelchair having a frame and a drive wheel pivot arm on each side of the wheelchair, each drive wheel pivot arm being mounted for pivoting with respect to the frame, with a drive wheel mounted on each drive wheel pivot arm, and further having a torsion member that is connected to each of the drive wheel pivot arms, thereby causing the two drive wheel pivot arms to tend to pivot in unison.

12. A wheelchair having a frame and a drive wheel pivot arm on each side of the wheelchair, each drive wheel pivot arm being mounted for pivoting with respect to the frame, with a drive wheel mounted on each drive wheel pivot arm, and further having a torsion member comprised of a main cross leg and two end legs, each end leg being connected to a drive wheel pivot arm.

13. The wheelchair of claim 12 in which the two end legs are rigidly attached to the drive wheel pivot arms.

14. The wheelchair of claim 13 in which the two end legs are attached to the drive wheel pivot arms through an adjustable linkage.

15. The wheelchair of claim 12 in which the two end legs are attached to the drive wheel pivot arms through a pivoting linkage.

16. The wheelchair of claim 15 in which the pivoting linkage is also an adjustable linkage.

17. The wheelchair of claim 12 in which the cross leg differs from the two end legs.

18. The wheelchair of claim 17 in which the cross leg has a different stiffness than that of the two end legs.

19. The wheelchair of claim 17 in which the cross leg is of a different material than that of the two end legs.

20. The wheelchair of claim 12 in which the end legs are removable so that end legs of different lengths can be substituted where desired.

21. The wheelchair of claim 12 in which the connector is splined to enable a preset torque on the torsion member.

22. A wheelchair with a suspension system comprising:
a drive wheel;
a front caster housing in which a front caster wheel is mounted; and
a front linkage supporting the front caster housing and connecting the front caster housing to the wheelchair frame, with the front linkage including upper and lower links connected at forward ends to the front caster housing, and connected at rearward ends to a pivot member that is pivotally mounted to the frame.

23. The wheelchair of claim 22 in which the drive wheel is mounted on a pivotally mounted drive wheel pivot arm, the drive wheel pivot arm being mounted for pivoting with respect to the frame about a drive wheel pivot arm pivot point, and in which the pivot member pivots with and is attached to the drive wheel pivot arm.

24. A wheelchair having a frame, with a wheelchair suspension system comprising:
a drive wheel;
a front caster housing in which a front caster wheel is mounted; and
a front linkage supporting the front caster housing and connecting the front caster housing to the wheelchair frame, with the front linkage including upper and lower links connected at forward ends to a front mounting bar from which the front caster housing is mounted, with the frame, the front mounting bar, and the upper and lower caster links forming a 4-bar link, and with a spring positioned between the front caster housing and the front mounting bar so that the front caster can spring rearward upon impact of the front caster wheel with an object.

25. The wheelchair of claim 24 in which the spring is a wave washer spring set.
